(19) United States
(12) Patent Application Publication
(10) Pub. No.: US 2025/0189387 A1
(43) Pub. Date: Jun. 12, 2025

(54) Fast Well Plate Differential Scanning Micro-Calorimeter Using Photonic Sensors

(71) Applicants: Northeastern University, Boston, MA (US); The Charles Stark Draper Laboratory, Inc., Cambridge, MA (US)

(72) Inventors: Gregory J. Kowalski, Beverly, MA (US); Dale N. Larson, Waban, MA (US); Jason O. Fiering, Boston, MA (US); Yuwei Zhang, Malden, MA (US)

(21) Appl. No.: 18/842,756

(22) PCT Filed: Mar. 13, 2023
(86) PCT No.: PCT/US2023/064223

§ 371 Date: Aug. 29, 2024

Related U.S. Application Data
(63) Continuation-in-part of application No. 17/658,950, filed on Apr. 12, 2022.
(60) Provisional application No. 63/269,286, filed on Mar. 14, 2022.

(51) Int. Cl. G01K 17/00

(52) U.S. Cl. CPC G01K 17/003

(57) ABSTRACT

A system for calorimetry includes a plurality of wells disposed upon a well plate, an input feature to deposit a sample within each well, and light sources configurable to irradiate each of the wells in the well plate, and their samples, with incident light. A photonic sensor chip at a bottom of each well includes a plural nanohole array sensor on a substrate. A light detector positioned below the well is configured to measure the transmission of light through the sensors, obtaining a series of optical transmission measurements. A heater is in thermal contact with each of the wells, applying a transient thermal increase to each well, and the sample therein, at a known heat rate. A processor is configured to calculate a measurement for each well as a function of the series of optical transmission measurements and the transient thermal increase, the measurement being indicative of the sample within the well undergoing a change in response to the transient thermal increase, the change relating to a property of the sample.

### RELATED APPLICATIONS

This application claims the benefit of U.S. Provisional Application No. 63/269,286, filed on Mar. 14, 2022. This application is a continuation-in-part and claims priority to U.S. application Ser. No. 17/658,950, filed on Apr. 12, 2022. The entire teachings of the above applications are incorporated herein by reference.

### BACKGROUND

Calorimetry involves measuring energy released or absorbed by a reaction over a range of reactant concentrations, and determining the thermodynamic properties, stoichiometry, and equilibrium binding constant for the reaction from the measured transfer of energy.

Temperature sensors conventionally employed for determining the heat of a chemical reaction in calorimetry studies include thermocouples, thermopiles, and/or thermistors. Other temperature sensing methods include sensors with microfluidic channels and have used changes in optical properties to infer temperature changes in reactions.

### SUMMARY

A system for calorimetry includes a plurality of wells disposed upon a well plate, each well having a volume for receiving a respective sample, and an input feature, including an injection device configured to access the volume of each of the plurality of wells and deposit the respective sample therein. A plurality of light sources is configurable to irradiate each of the plurality of wells and the respective sample with incident light. The system includes a plurality of photonic sensor chips, each photonic sensor chip disposed at or forming a bottom of each corresponding well of the plurality of wells. The photonic sensor chip includes plural nanohole array (NHA) sensors integrated upon a substrate. The system further includes a light detector configured to measure transmission of light through the NHA sensors to obtain a series of optical transmission measurements. A heater is in thermal contact with each of the plurality of wells. A heater controller is coupled to the heater, the heater controller programmed to control the heater to apply a transient thermal increase to each well, to increase the temperature within the well at a known heat rate, with the sample provided therein. A processor is configured to calculate, for each well, a calorimetry measurement as a function of the series of extraordinary optical transmission measurements, or other forms of optical transmission measurements, and the transient thermal increase, the calorimetry measurement being indicative of the sample within the well undergoing a change in response to the transient thermal increase, the change for each sample relates to a property of the sample. The measurement may be indicative of energy released as a result of the sample within the well undergoing a change in response to the transient thermal increase.

The system can include at least one power supply configured to independently control the intensity of the light sources within a range of intensities between 0 and 500 lux, according to a voltage setting of the at least one power supply.

The at least one power supply can be spatially separated from the calorimetry unit and includes at least one battery, or a switchable DC power supply device.

Each light source can include a light-emitting diode (LED) and a collimator operatively coupled with the LED to control a direction of rays of light emitted by the LED.

The heater can be positioned as a peripheral heater in thermal contact with a perimeter of each of the plurality of wells.

The system can include plural heaters. The heaters can be peripheral heaters, and each well can be in thermal contact with an individual peripheral heater.

The system can include frame elements configured to secure and mutually couple the light sources, the photonic sensor chip of each well, the light detector, and the input feature to form a calorimetry unit for each well.

The system can include a lens configurable to focus upon the light detector, light transmitted as an optical transmission through the NHA sensors of each of the photonic sensor chips disposed at or forming a bottom of each of the plurality of wells, the system further including a lens frame element configured to secure the lens and to be mutually and physically coupled with one or more other frame elements of the calorimetry unit.

The light detector can include a plurality of light detectors, each of the plurality of light detectors arranged to measure light transmitted as an optical transmission through the NHA sensors of one well of the plurality of wells.

The system can include an optics controller configured to control aspects of at least one of the light sources and the light detector, the system further including memory configured to store data acquired from the light detector.

The processor, the optics controller, and the memory of the system can be integrated within an electronic microcontroller device operatively coupled with, and spatially separate from, the calorimetry unit.

The optics controller can be programmed to cause the light detector to capture, and store in the memory, video data including a plurality of image frames for a view of all of the NHA sensors of the plurality of wells. The processor can be further configured to crop each of the image frames, containing a view a view of all of the NHA sensors of the plurality of wells, into a plurality of cropped image frames, each cropped image frame containing a view of a corresponding individual well of the plurality of wells. For each of the plurality of cropped image frames, the processor can use the information from the cropped image frame to calculate the calorimeter measurement for the corresponding individual well.

For each of cropped image frames, if the stored video data includes color video data, the processor is configured to convert the color video data to black and white video data. The processor can be further configured to identify bright spots, corresponding to individual NHA sensors, represented in the stored video data by; comparing, with a brightness threshold value, brightness information corresponding to pixels represented within the stored video data; and determining locations within the view where the brightness information exceeds the threshold value. The processor can be further configured to average brightness information corresponding to pixels represented within the stored video data for a given individual NHA sensor, the averaging performed spatially over a pixel array of pre-defined dimensions, the pixel array defining a region that includes at least part of the given NHA sensor.

A method for calorimetryincludes providing a sample to each of a plurality of wells disposed upon a well plate via an input feature configured to access the volume of each of the plurality of wells and depositing the respective sample therein, and configuring a plurality of light sources to irradiate each of the plurality of wells and the respective sample with incident light. The method includes measuring, via a light detector, transmission of light through plural nanohole array (NHA) sensors to obtain a series of optical transmission measurements, the NHA sensors integrated upon a substrate of a photonic sensor chip disposed at or is placed at the bottom of each of the plurality of wells. The method further includes controlling a heater to apply a transient thermal increase to each well, increasing the temperature within each well at a known rate, and calculating, for each well, a measurement as a function of the series of optical measurements and the transient thermal increase for each well, the calorimetry measurement being indicative of the sample in the well undergoing a change in response to a transient thermal increase to the well, wherein the change for each sample relates to a property of the sample.

The input feature can include an injection device, in which caseroviding the sample to a well of the plurality of wells can include configuring the injection device to access the volume of each well and to deposit the sample therein.

The method can include configuring at least one power supply to independently control an intensity of the light sources within a range of intensities between 0 and 500 lux according to a voltage setting of the at least one power supply, thereby tuning an amount of light transmitted as an optical transmission through the NHA sensors of the photonic sensor chips for improved detection of the change undergone by the sample in each of the plurality of wells according to the calorimetry measurement.

The method can include measuring transmission of light by capturing, and storing in memory, video data representing light transmitted as an optical transmission at least through the NHA sensors of the photonic sensor chip disposed at or forming a bottom of each of the plurality of wells. If the stored video data includes color video data, the color video data can be converted to black and white video data. The method can further includes identifying bright spots, corresponding to individual NHA sensors, represented in the stored video data by comparing, with a brightness threshold value, brightness information corresponding to pixels represented within the stored video data; and determining locations within the view where the brightness information exceeds the threshold value. The method can further include averaging brightness information corresponding to pixels represented within the stored video data for a given individual NHA sensor, the averaging performed spatially over a pixel array of pre-defined dimensions, the pixel array defining a region that includes at least part of the given NHA sensor.

The method can include programming an optics controller to cause the light detector to capture, and store in the memory device, video data comprising a plurality of image frames for a view of all of the NHA sensors of each of the plurality of wells. The method can include cropping the image frames containing a view a view of all of the NHA sensors of each of the plurality of wells into cropped image frames, each cropped image frame containing a view of an individual well of the plurality of wells, wherein for each of the plurality of cropped image frames.

For any of the systems or methods described herein, the optical transmission may be extraordinary optical transmission (EOT).

### BRIEF DESCRIPTION OF THE DRAWINGS

The foregoing will be apparent from the following more particular description of example embodiments, as illustrated in the drawings hereinbelow. The drawings are not necessarily to scale, emphasis instead being placed upon illustrating embodiments.

FIG. 1 is a block diagram of an example micro-calorimetry system according to embodiments of the present disclosure.

FIG. 2A is a schematic diagram of an example Nano-Hole Array (NHA) sensor and light detector to be used in micro-calorimetry systems according to embodiments of the present disclosure.

FIG. 2B is a perspective view of an example Nano-Hole Array (NHA) sensor to be used in micro-calorimetry systems according to embodiments of the present disclosure.

FIG. 3A includes a close-range view of an example Nano-Hole Array (NHA) sensor to be used in micro-calorimetry systems according to embodiments of the present disclosure, and a magnified view of a single Nano Hole Array of the example NHA sensor.

FIG. 3B is a graphically displayed still representation of video data captured by a light detector used in micro-calorimetry systems according to embodiments of the present disclosure.

FIG. 3C is a graphically displayed still representation of video data captured by a light detector used in micro-calorimetry systems.

FIG. 4A is a schematic diagram of an example calorimetry unit to be used in a micro-calorimetry system according to an embodiment.

FIG. 4B is a schematic diagram of an example implementation of calorimetry units to be used in a micro-calorimetry system according to an embodiment.

FIG. 4C is a section view of an example light source to be used in a micro-calorimetry system according to an embodiment.

FIG. 4D is a section view of an example well to be used in a micro-calorimetry system according to an embodiment.

FIG. 4E is a section view of an example light detector of a plurality of light detectors located in each well of a plurality of wells to be used in a micro-calorimetry system according to an embodiment.

FIG. 4F is a schematic diagram of an example implementation of calorimetry units to be used in a micro-calorimetry system illustrating a single light detector below a plurality of wells according to an embodiment.

FIG. 5A is a perspective view of a frame element for holding a light source of an example calorimetry unit to be used in a micro-calorimetry system according to an embodiment.

FIG. 5B is a cross-sectional view of frame element for holding a light source of an example calorimetry unit to be used in a micro-calorimetry system according to an embodiment.

FIG. 6A is a perspective view of a Nano Hole Array (NHA) chip of an example calorimetry unit to be used in a micro-calorimetry system according to an embodiment.

FIG. 6B is a diagram showing an expanded view of an example single NHA sensor, and an example video camera view illustrating a pixel representation of extraordinary optical transmission (EOT) through the sensor, according to an embodiment.

FIG. 7A is a perspective view of a light detector of an example calorimetry unit to be used in a micro-calorimetry system according to an embodiment.

FIG. 7B is a cross-sectional view of a light detector of an example calorimetry unit to be used in a micro-calorimetry system according to an embodiment.

FIGS. 8A-8C are exemplary images of extraordinary optical transmission (EOT) through an NHA chip of an example calorimetry unit to be used in a micro-calorimetry system according to an embodiment.

FIG. 9A is a plot of measured EOT vs. time and well temperature vs. time for a well into which a sample of ethanol is injected during testing, according to an embodiment. Measured EOT is plotted as EOT difference with respect to an initial EOT value.

FIG. 9B is a plot of measured EOT vs. individual NHA sensors for different concentrations of samples, according to an embodiment.

FIG. 10A is a schematic diagram of an exemplary photonic sensor chip containing a rectangular arrangement (e.g., a strip) of NHA sensors according to an embodiment.

FIG. 10B illustrates a light detector view viewing a individual well including an NHA sensor strip.

FIG. 11A is a schematic diagram of an exemplary photonic sensor chip containing a circular arrangement of NHA sensors according to another embodiment.

FIG. 11B is a schematic diagram of an exemplary NHA pattern according to an embodiment.

FIG. 12A is a plot showing the transient thermal response of a sample which does not undergo a change in response to an applied heat.

FIG. 12B is a plot showing the transient response of a sample underoing a change, for example, a reaction, folding or unfolding of a protein, denaturing of the compound or a phase change, in response to an applied heat.

### DETAILED DESCRIPTION

A description of example embodiments follows.

A Fast Well Plate Differential Scanning Micro-Calorimeter Using Photonic Sensors (DSCWP) is a device that may be used in the early stages of drug discovery and may be used to investigate (i) protein unfolding energy exchanges, (ii) denaturing of biological materials, (iii) DNA and RNDA reactions, or (iv) energy releases in materials due to magnetic or phase changes related to temperature changes. For drug discovery applications, DSCWP is compatible with robotic injection systems commonly used in pharmaceutical laboratories. The small size of the DSCWP allows each well in a, for example, 96 or 384 well plate to be a micro-calorimeter, which is consistent with high throughput screening of small amounts of compound, and provides useful thermodynamic data that describes a reaction taking place. In pharmaceutical use, DSCWP allows a better choice of drug candidate for further development. DSCWP uses a photonic sensor to determine a change in Extraordinary Optical Transmission (EOT) through an array of nanoholes (NAS) to measure temperature and concentration change in a sample of interest while it is being heated to a specified temperature. The differential scanning approach described herein allows for rapid identification of melting or ignition points in the sample. It is further expected that the present disclosure will introduce a new market segment of calorimetry. The approach described herein further allows for multiplexing of testing, allowing multiple different tests to be performed on the same well plate at the same time.

Embodiments provide a method and system for calorimetry, i.e., for performing calorimetric testing on one or more samples. Such samples may be in fluid form (e.g., a liquid solution, or a gas). Alternatively, or in addition, such samples may be in other forms, such as solid form (e.g., a powder, a crystal, an alloy, or any other solid form of matter known in the art). Such samples may enter via an input feature of a test chamber, i.e., a well, of such a system for calorimetry, for example by being injected via an injection device, or by passively moving through an input feature such that the input feature functions as a diffusion feature.

Calorimetric testing may be performed, using the disclosed method and system, to study different phenomena depending upon the nature or form of the one or more samples. Testing may be performed to determine an amount of energy released or absorbed in a process of a change undergone by the one or more samples, e.g., a chemical reaction; a denaturing of molecules; an unfolding of proteins; a phase change of matter such as melting, vaporization, solidification or freezing, condensing, etc.; and other types of changes in matter known in the art.

In some embodiments, a photonic sensor-enabled micro-calorimeter device may be used in early stages of drug discovery, genome investigation; and to investigate energy exchanges related to protein unfolding, denaturing of biological materials, or DNA, MRNA, and RNA reactions; or energy releases in materials due to magnetic or phase changes. It is compatible with robotic injection systems commonly used in pharmaceutical laboratories.

Instances of the device may be sized so as to configure individual wells in a well plate to be micro-calorimeters. Well plates used as such may include a standard quantity of wells, such as, for example, a well plate with 96 wells, a well plate with 384 wells, and well plates with other numbers of wells. Such configurations support high throughput screening using small amounts of compounds as samples. Such configurations also facilitate gathering of thermodynamic data that can be analyzed to identify promising drug candidates for further development.

Embodiments use a photonic sensor to determine a change in extraordinary optical transmission (EOT) through an array of nanoholes to measure temperature and concentration change in a sample of interest. A photonic sensor chip may be composed of a metallic film that is deposited on a dielectric substrate. A nanohole array (NHA) pattern may be micro-manufactured using a nano, micro, or MEMS manufacturing process, or a combination of techniques thereof, in the metallic film. Such an NHA sensor may include, for example, a 10×10 or a 3×3 array of apertures with a diameter of 150 nm and pitch size of 350 nm. Using a two-dimensional array of odd digits, such as a 3×3 array, is advantageous so the center of the array can be located quickly; however a larger array, such as 10×10 array, works as well due to the large amount of nanoholes present. These small holes can be made by using Focused Ion Beam or lithographic type processes on a 100 nm gold layer on a glass substrate. Suitable NHA sensor configurations and dimensions are described, for example, in U.S. Pat. Nos. 8,076,151; 9,377,422; and 10,677,661.

Devices and methods for ultra-sensitive temperature sensing and calorimetry have been described by Larson and Kowalski in International Patent Application Publication WO2008/088829, published Jul. 24, 2008, and corresponding U.S. Pat. No. 8,076,151 to Larson and Kowalski, issued Dec. 13, 2011, the teachings of which are incorporated herein by reference in their entirety.

A system and method for a microfluidic calorimeter have been described in U.S. Pat. No. 9,377,422 to Fiering et al., issued Jun. 28, 2016, the teachings of which are incorporated herein by reference in their entirety. Another system and method for a microfluidic calorimeter have been described in U.S. Pat. No. 10,677,661 to Modaresifar and Kowalski, issued Jun. 9, 2020, the teachings of which are incorporated herein by reference in their entirety.

In an example embodiment, the well plate-calorimeter device, may be a single use instrument that can be returned to the manufacturer for recycling. This eliminates the need to clean the well plate, and increases the speed of conducting experiments.

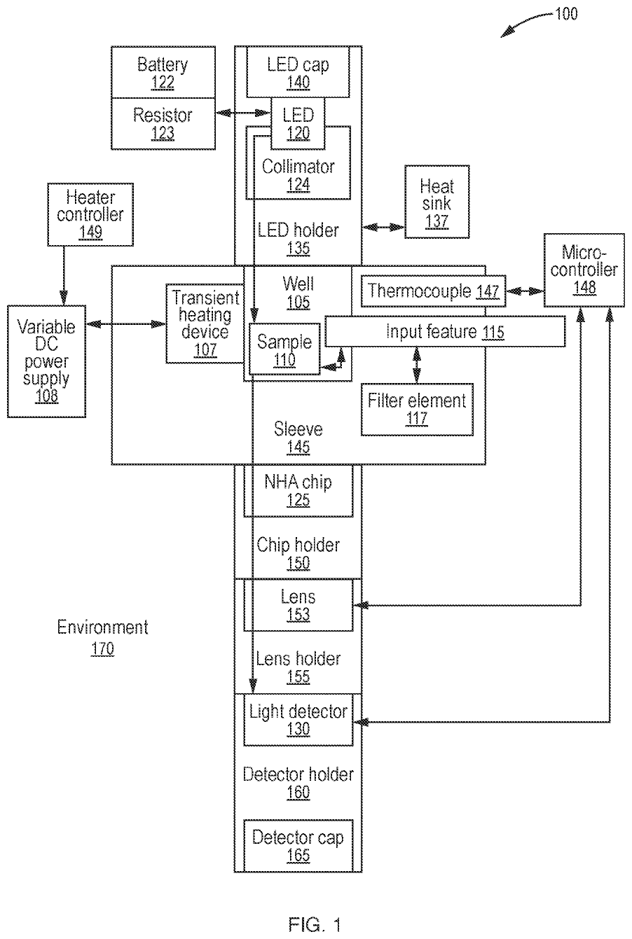

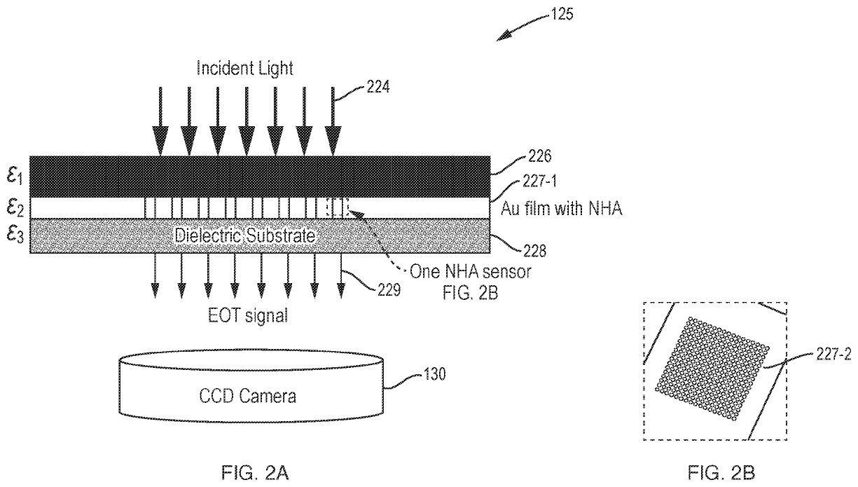

In an embodiment, the photonic sensor is composed of a metallic film that is deposited on a dielectric substrate. The nanohole array pattern is micro-manufactured using different nano, micro, or MEMS techniques in the metallic film. The NAS photonic chip is placed in the bottom of a transparent well (see FIGS. 1 and 2A-2B below). The well is filled with the protein. Means of injecting a reactant (ligand or drug candidate), such a microfluidic injector, dip pen, or automated pipette, is positioned asymmetrically in the well. A transient heating device is attached to the perimeter of the test cell to apply a transient thermal increase to the reaction, and as a means of calibrating each well-based micro-calorimeter. The same transient heating device is used to change the temperature of the sample between the initial and final values of the test. For example, a constant voltage within a range of 0.3V-1.0V may be applied to the heating device in order to produce a thermal increase to the samples within the well. Such a transient heating device may be used to calibrate an individual micro-calorimeter or multiple micro-calorimeters of a well plate-based embodiment. The transient heating device may be a thermoelectric heater, a resistive coil heater, or any other heating apparatus known in the art. The transient heating device includes a variable DC power supply connected across a pair of heater wire terminals of a material such as nichrome. Applying the voltage to the heating device increasingly changes the temperature within the respective well, and thus provides a transient thermal increase to the sample within each well.

In example embodiments, the photonic sensor is composed of a metallic film that is deposited on a dielectric substrate. A nanohole array pattern may be micro-manufactured using nano, micro or MEMS techniques in the metallic film. In these embodiments, the photonic sensor, i.e., the NHA sensor, forms the bottom of the well in the well plate. A circumferential transient heating device is positioned about the perimeter of the well, and located outside of the well. The transient heating device may be configured to control a temperature of material inside the well, as well as to provide calibration information. This transient heating device may also insulate each well from the temperature variations in adjacent wells, thus preventing cross-talk in the EOT measurements between wells. A micro pipette may be asymmetrically positioned relative to the well, and may function as an injection device included within an input feature of the well. The micro-pipette thus may be used to inject a fluid sample into the well. Alternatively, fluid samples, including potential reactants, may flow into and out of the well using a microfluidic delivery system. The transient heating device may be turned on to provide a transient thermal increase to the sample while a monochromatic, collimated beam of light is passed through the well and is incident on the photonic chip. As described hereinabove, the incident light on the metallic film creates a surface plasmon resonance with the nanohole pattern that amplifies the EOT, which, in turn, is recorded by a light detector. The light detector may be a CCD chip, which may be configured such that one light detector is positioned to view each well, of the plurality of wells, at once; or may be configured such that a light detector is installed in each well of the plurality of wells of the well plate.

The cameras may be CCD cameras, or may be other devices capable of recording video data. The EOT thus viewable by such light detectors is related to a ratio of the dielectric constants of the sample material and that of the metallic film. The EOT varies in relation to the changes in the dielectric constants which are dependent on the temperature and concentration of the sample. The changes in the temperature and concentration are directly related to the energy released from a reaction involving the sample.

Since the EOT varies in relation to the changes in the dielectric constants, which are dependent on the temperature and concentration of the sample in the well, the changes in the temperature and concentration are directly related to the energy released from the reactions occurring in the well. The changes in the transmitted light are recorded by an optical device such as CCD or CMOS camera or photomultiplier tubes. A post-processing algorithm will reduce the images of the transmitted light to be related to the temperature, concentration changes, and energy released in each well.

According to embodiments, a photonic chip, and a test chamber associated therewith, are placed into thermal contact (e.g., physical contact or proximal disposition) with a transient heating device, the transient heating device is turned on to apply a transient thermal increase to a sample within the well. The transient heating device may be a thermoelectric heater, a resistive coil heater, or any other heating apparatus known in the art. A monochromatic, collimated beam of light may be passed through the well and may be incident on the photonic chip. The incident light on the metallic film creates a surface plasmon resonance with the nanohole pattern that amplifies the transmitted light through the nanoholes; the EOT. This transmitted light is related to the ratio of the dielectric constants of the sample material and that of the metallic film. Such amplification produces extraordinary optical transmission (EOT) according to equations (1) through (3) below, wherein I is intensity transmitted through sensor, λₚ is the wavelength at peak intensity, h is the metallic film thickness, dis hole diameter, α₀ is the grid or matrix constant, γ is an integer mode constant, and ε₁ and ε₂ are dielectric constants of the dielectric materials, i.e., of the sample and of the metallic film respectively. The EOT signal further depends upon variations of the dielectric constant of the sample of interest ε₁ with respect to temperature (T), concentration change ([C]), and pressure (P) in the sample, as shown in equation (3). Equation (3) specifically describes changes in the sample's dielectric constant, ε₁, with respect to temperature and concentration changes that alter the wavelength of peak intensity, λₚ, as shown in equation (2), which then alters the EOT as shown in equation (1).

$$EOT = I ( h , {λ}_{p} , d ) ∝ exp ( \frac{- 4 π h}{{λ}_{p}} \sqrt{{( \frac{{λ}_{p}}{1.7 d} )}^{2} - 1} ) \qquad ( 1 )$$

$${λ}_{p} = \frac{{a}_{0}}{γ} ⌊ {( \frac{{ε}_{1} {ε}_{2}}{{ε}_{1} + {ε}_{2}} )}^{1 / 2} - sin θ ⌋ \qquad ( 2 )$$

$$d ε = \frac{\partial {ε}_{1}}{\partial T} {\vert}_{P , C} dT + \frac{\partial {ε}_{1}}{\partial P} {\vert}_{T , C} dP + \frac{\partial {ε}_{1}}{\partial [ C ]} {\vert}_{P , T} d [ C ] \qquad ( 3 )$$

The EOT thus varies in relation to the changes in the dielectric constants of the sample that are dependent on the temperature and concentration of the sample. The aforementioned U.S. Pat. No. 8,076,151 to Larson and Kowalski, specifically including columns 7 and 8 thereof, describes in additional detail the interactions between nanoholes of an arrangement of NHA sensors, and photons of light incident thereto, according to dielectric constants of materials of the arrangement of NHA sensors.

The changes in the temperature and concentration are directly related to the energy released from changes undergone by the sample, e.g., the reactions, phase changes, or similar physical phenomena occurring in the sample material. The aforementioned U.S. Pat. No. 8,076,151 to Larson and Kowalski, and U.S. Pat. No. 10,677,661 to Modaresifar and Kowalski provide equations and supporting descriptions to explain such relationships between energy released from the sample and changes in temperature and concentration thereof.

Benefits of using a photonic sensor include its small size and sensitive response to these changes. For water based materials, the sensitivity of the photonic sensor may be estimated to be, e.g., 5 picojoules, and a size of the sample can be as small as e.g., 25 nL, or smaller. The response speed of the photonic sensor approaches the speed of light. These size and response limits are orders of magnitudes, from a factor of 20 to 500, different from currently available calorimeters.

A variation of the example embodiment of the device would be to observe the EOT through the sample as it is heated to a maximum temperature. Such an EOT versus time response may follow an expected temperature versus time curve, until a change, e.g., an energy release or absorption process occurs. The expected temperature versus time curve may be obtained, for example, by measuring power dissipated by the transient heating device as the transient heating device functions to apply a transient thermal increase to the test chamber. The process of the change causes a significant variation in the observed EOT trend. This change, and knowledge of the heat flow through the sample, provide a means to measure a magnitude of the energy released by using the time of the event. Such knowledge of heat flow may be established via measurement thereof, derived from a signal controlling the transient heating device, understood simply via pre-set specification, or by a combination of the aforementioned techniques, with or without other techniques presently known in the art. Once the change is identified, and once the EOT versus temperature relationship is calculated, other thermodynamic properties, such as entropy flow, Gibbs free energy, and equilibrium constant, may be determined.

An alternative to the above procedure uses an observed EOT trend and an expected EOT versus temperature relationship to determine an amount of energy released from the sample. The expected EOT versus temperature relationship may be obtained prior to testing the sample, by performing a calibration procedure. Similar relationships for determining the entropy flow, the Gibbs free energy, and the equilibrium constant may be used.

The benefits of using a photonic sensor are its small size and sensitive response to the changes. For water-based materials, the sensitivity of the photonic sensor is estimated to 5 picojoules and size of the sample can be as small 25 nl. The response speed of the photonic sensor approaches the speed of light. These size and response limits are orders of magnitudes different from currently available calorimeters by a factor of 20 to 500. The photonic sensor, because of its optical excitation and recording, does not require wire type connections to each well, which increases its compatibility with existing laboratory arrangements.

In the preferred embodiment, the photonic sensor is as small as 3 microns square, which allows a small sample volume to be used and provides a multitude of additional benefits. For example, the sensor can be placed into a single well of a well plate. The small size of the sensor also allows for slow reacting compounds, such as sugar proteins, to be directly investigated without additional chemical amplification steps. Further, the small size of the sensor reduces compound consumption as well as cost and time of the test; an order of reduction in test time and a 20-time reduction in compound consumed is expected with this small photonic sensor size. In addition, the small size and the photonic characteristic of the sensor allows the device to be multiplexed on a single chip for high throughput applications. The increased sensitivity of the chip allows it to be sued with, for example, sugar proteins, where these materials typically have small energy releases when they interact.

The transient heating device assembly can be precast with a single electrical connection to the power source and/or thermal control unit. This device would allow the thermodynamic properties such as entropy flow, the Gibbs free energy, and the reaction equilibrium constant to be determined in each well, which could contain different drug candidates and control reactions. The compatibility of the proposed device with current, early-stage pharmaceutical testing procedures, while providing advanced information about the reaction, is a niche currently not filled by any device.

In one example embodiment, a photonic chip is manufactured by depositing a metallic film (gold) over a dielectric substrate (glass). A pattern of nanoholes, approximately 150 nm in diameter placed at a pitch of 300 nm, are drilled into this film using techniques such as focused ion beam (FIB) or by lithography means.

The photonic chip may be sized to fit into the bottom of each well in the well plate. The typical pattern is an array size of N×N (N≥3) nanoholes, e.g. 3×3 nanoholes, which defines the NHA sensor, and typically nine sensors would be placed in each well.

In some embodiments, the photonic chip is placed in the bottom of a test chamber, which test chamber may be embodied as a well. The well may be filled with buffer and a first reactant, reactant A, which may be a protein, or another type of reactant. A second reactant, reactant B, which may be a ligand or drug candidate, or another type of reactant, may then be added to the well. An input feature, such as an injection device, which may include an injection device such as a microfluidic injector, dip pen, automated pipette, or other device as is commonly used in the art, may be positioned asymmetrically in the well.

In some embodiments, the NHA sensor is fabricated by the manufacturer as simultaneously forming the bottom of the well, being integral to it.

A monochromatic LED 632 nm light with a beam divergence of 5 degrees, for example, is positioned above each well to provide the incident light. The positioning is such that it allows fluid delivery device to enter the well near its circumference. This injection site allows both the thermal and concentration front of the reaction to be observed as it moves over the photonic chip. The transmitted light through the photonic chip may be recorded as image or video data by an optical device such as a CCD or CMOS camera mounted below the well, or a CCD chip located under the well. Such recorded image or video data may be acquired and analyzed using a computer to recognize and quantify changes occurring in the transmitted light, i.e., the EOT.

In some embodiments, computer-implemented methods include analyzing image or video data of EOT, recorded by the optical device, to examine characteristics of changes occurring to a sample in a well, such as changes in temperature, concentration, and energy being released as a result of a reaction involving the sample.

The device facilitates determination of thermodynamic properties of materials in the well, such as entropy flow, Gibbs free energy, and a reaction equilibrium constant, which may include various drug candidates, and which may house controlled reactions involving such drug candidates. The compatibility of the device with current, early-stage pharmaceutical testing procedures, while providing advanced information about reactions occurring inside the well, is a niche currently not filled by any device.

The transient heating device is turned on to cause a transient thermal increase to each well depending on the experiment. A computer acquisition system is turned on a few seconds before images of each well are captured, where the images are used to observe the changes in the transmitted light.

The testing and measurement starts by exposing each well to the monochromatic collimated beam of light that is incident on the photonic chip. A detector, CCD camera, or other means to view the transmitted light through the photonic chip, is placed underneath the well plate. The detector records all transmitted light. A calibration procedure is used to determine the relationship between the temperature and EOT values. The transient heating device is turned on, and the transmitted light through the chip is recorded as a function of time. The heater power through the chip sample is also recorded as a function of time.

The collected data is analyzed to determine the time and EOT value at which an observable deviation from the expected monotonic EOT-vs time relationship is observed. The EOT-Temperature calibration can be used to determine the energy released during the variation between the expected monotonic path and the observed variation in the EOT.

A calibration procedure may be used to determine a relationship between the temperature within the well and corresponding values of EOT. In an example calibration procedure, the transient heating device is turned on, and the EOT is recorded as a function of time. The transient heating device's power may also be measured as a function of time. An expected monotonic EOT vs. time relationship may thus be established, with information, as to an associated level of energy released within the well, attainable via the heater power data.

The EOT data, subsequently collected during an experiment within the well populated by a sample, may then be analyzed to determine a time value and corresponding EOT value at which an observable deviation from the expected monotonic EOT vs. time relationship is observed. The energy released, during a time period including the variation between the expected monotonic EOT vs. time relationship and the observed EOT values, may then be calculated using the heater power data. Computer-implemented calibration methods based on thermodynamic relationships may be used for analyses other than determinations of energy released, such as entropy change and reaction equilibrium constant, which are useful parameters for selecting promising drug candidates for further research in a development process thereof.

An embodiment of the proposed device observes EOT through a sample as the sample undergoes a transient thermal increase. An EOT-time response may follow an expected temperature-time curve until an energy release or absorption process occurs within the well. The energy release process causes an observable variation in the observed EOT trend. This variation, compared with knowledge of heat flow through the sample obtained prior to the variation, enable the magnitude of energy released at the time of the variation to be determined. Once this energy release is determined, the EOT-temperature relationship may allow other thermodynamic properties, such as entropy flow, the Gibbs free energy, and the equilibrium constant, to be determined.

A sensor may move within its well due to changes in the temperature during the experiment. To overcome this problem, a field capture method or process may be used to measure and post-process the EOT values. In the field capture process, video data for a view of the NHA sensors is captured and stored in memory. As mentioned above, in some embodiments, the view includes every NHA sensor array on the photonic chip. Some embodiments are configured to process black-and-white video data; as such, embodiments of the field capture process include converting any color video data to black and white video data for processing.

Processing of the video data for NHA sensors begins by running a computer program configured to handle the post-processing of the video data, recorded by the light detector, by performing an image crop function on the image frames of the saved video. In the preferred embodiment, one light detector is configured to view each of the plurality of wells on the well plate. The movie saved by image capture device is read by image frames. For example, a 40 second movie contains 400 individual image frame pictures. The post-processing program then separates these image frames into individual images. In an embodiment containing, for example, 96 wells in the well plate, the post-processing code will crop the image frames containing a view of 96 wells into 96 individual cropped image frames containing one unique single well in each cropped image frame. In an embodiment, the code is configured to identify the four wells in the well plate located in the respective corners of the well plate; the subsequent locations of each individual well can be calculated based off the known locations of the corner wells in the well plate. Further post processing of the NHA sensors for each individual well continues on the isolated well cropped image frames.

The processing of the video data for NHA sensors continues by identifying bright spots, corresponding to individual NHA sensors, represented in the stored video data. Bright spots may be identified by examining brightness information corresponding to pixels represented within the stored video data, and comparing the brightness information with a pre-determined or pre-set brightness threshold value. Such identification of bright spots may be performed using a publicly-available data analysis software application such as MATLAB, among other applications. In some embodiments, x-y coordinates of individual pixels, or groups thereof, corresponding with the identified bright spots are defined relative to an origin. Such x-y coordinates may be stored in memory for later reference. Where the view includes every NHA sensor array on the chip, a post-processing step may be applied to crop the video frames to view each individual well.

The field capture process continues by referring to the defined x-y coordinates of identified bright spots, and performing a pixel averaging procedure incorporating brightness data corresponding to neighboring pixels of the respective pixels corresponding to the identified bright spots. For a given bright spot, such neighboring pixels, along with the pixel(s) corresponding with the identified bright spots, together represent video data for a given NHA sensor. The pixel averaging procedure for a given bright spot may be a spatial average incorporating brightness data corresponding to pixels comprising a pixel array of pre-defined dimensions. Such a pixel array may define a region that includes at least a part of the given NHA sensor, but, preferably, the whole NHA sensor. The pre-defined dimensions of the pixel array may, for example, be any odd number of pixels in x- and y-directions, such as 3, 5, 7, 9, or 11 pixels, etc. The number of pixels in the x-direction may or may not be the same as the number of pixels in the y-direction. In a best-mode implementation of the pixel averaging procedure, pre-defined dimensions of 13×13 pixels, respectively in the x- and y-directions, were found to produce an array of pixel data with a lowest level of observed measurement noise. Pre-defined dimensions for such a best mode may vary depending upon the specific CCD camera used to capture the video data, and may be determined empirically therefrom.

In an alternative embodiment, the transient heating device's power through the chip sample is monitored during the time of deviation. This information is then used to determine, for example, the energy released using the observed temperature change. Algorithms based on thermodynamic relationships and calibration procedures may be employed to determine the energy released, entropy change, and/or reaction equilibrium constant, which are useful parameters for selecting the best drug candidates to move forward in a development process.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed or contemplated herein.

FIG. 1 is a block diagram of an example micro-calorimetry system 100 located in an environment 170. A system 100 for calorimetry includes a well 105, located within sleeve 145, having a volume for receiving a sample 110, an input feature 115 configured to facilitate reception of the sample 110 in the well 105, a light source 120 configurable to irradiate the well 105 and the sample 110 with incident light, and a photonic sensor chip 125 disposed at the bottom of the well 105. The photonic sensor chip 125 may include plural nanohole array (NHA) sensors integrated upon a substrate. Detector holder 160 contains a light detector 130 and the detector cap 165. Light detector 130 is configured to measure transmission of light through the NHA sensors to obtain a series of extraordinary optical transmission (EOT) measurements. The system 100 includes frame elements 135, 140, 150, and 155 that are configured to secure and mutually couple the light source 120, the photonic sensor chip 125, the light detector 130, and the input feature 115 (for example, micro-pipette 415) to form a calorimetry unit, as well as a heat sink 137. A processor is configured to calculate a calorimetry measurement as a function of the series of EOT measurements, the calorimetry measurement being indicative of energy released as a result of the sample 110 in the well 105 undergoing a change.

The input feature 115 can include an injection device, e.g. a micro-pipette, configured to access the volume of the well 105 and deposit the sample 110 therein.

The well 105 can be one of a plurality of wells disposed upon a well plate. The injection device can be configured to access the volume of each of the wells, or there can be multiple injection devices, e.g., one injection device for each well.

The system 100 can include at least one filter element 117 configured to control the flow of the sample 110 into the well 105. Such filters 117 may permit or arrest passage of samples of various sizes or structures into the well. For example, microbes or viruses may be allowed to pass into the well, or blocked by such filters 117.

The system 100 can include a light source power supply 122 configured to control an intensity of the light source 120 within a range of intensities between, for example, 0 and 500 lux, or other ranges, according to a voltage setting of the power supply 122. Such a voltage setting may be controlled via a selectable, switchable, or variable resistor 123 electrically coupled with the power supply 122. The system 100 may include a variable DC power supply 108 for the transient heating device 107 configured, via a heater controller 149, to control a transient thermal increase applied to the well 105 and the sample 110 therein 105. The light source power supply 122 and the variable DC power supply 108 for the transient heating device 107 can be spatially separated from the calorimetry unit and includes a variable DC power supply device. Using a variable DC power supply 108 for the transient heating device 107 promotes consistent application of a transient thermal increase to the well with minimal variation or degradation in heat applied, as opposed to batteries, which will result in less heat being applied to the well as the batteries discharge. The heater controller 149 may be integrated with the microcontroller 148.

The light source 120 can include a light-emitting diode (LED) and a collimator 124 operatively coupled with the LED to control a direction of rays of light emitted by the LED.

The system can include a transient heating device 107 in thermal contact with the well 105, and a heater controller coupled to the transient heating device, the heater controller programmed to control the transient heating device 107 to apply a transient thermal increase to the well 105 with the sample 110 provided therein.

The light detector 130 can include at least one of (i) a charge-coupled device (CCD) chip, a complementary metal oxide semiconductor (CMOS) device, or a photo-multiplier tube (PMT) positioned to receive light transmitted as an EOT transmission through the NHA sensors of the photonic sensor chip 125 disposed at the bottom of the well 105, and (ii) a camera positioned to receive light transmitted as an EOT transmission at least through the NHA sensors of the photonic sensor chip 125 disposed at the bottom of the well 105. For example, the light detector 130 can include a camera, and the camera can be positioned to receive light transmitted as an EOT transmission through NHA sensors of a plurality of photonic sensor chips 125, each photonic sensor chip 125 of the plurality of photonic sensor chips 125 being respectively disposed at the bottom of each well 105 in a well plate. There can be single light detector 130 positioned to view each of the plurality of wells in the well plate, or there can be plural light detectors, e.g., one detector each positioned at the bottom of each well in the well plate.

The system 100 can include a lens 153 configurable to focus, upon the light detector 130, light transmitted as an EOT transmission through the NHA sensors of the photonic sensor chip 125 disposed at the bottom of the well 105. A lens frame element 155 can be provided to secure the lens and to be mutually physically coupled with one or more other frame elements of the calorimetry unit.

The system 100 can include an optics controller configured to control aspects of at least one of the light source 120, the lens 153, and the light detector 130. The system 100 can further include memory configured to store data acquired from the light detector 130. The processor, the optics controller, and the memory can be integrated within an electronic microcontroller device 148 operatively coupled with, via thermocouple 147, and spatially separate from, the calorimetry unit.

A method for calorimetry includes providing a sample 110 to a well 105, or otherwise permitting the sample 110 to enter the well 105, via an input feature 115, configuring a light source 120 to irradiate the well 105 and the sample 110 with incident light, and measuring, via a light detector 130, transmission of light through plural NHA sensors to obtain a series of EOT measurements. The NHA sensors can be integrated upon a substrate of a photonic sensor chip 125 disposed at the bottom of the well. A calorimetry measurement can be calculated as a function of the series of EOT measurements, the calorimetry measurement being indicative of energy released as a result of the sample 110 in the well 105 undergoing a change.

The input feature 115 can include an injection device. Providing the sample 110 to enter the well 105, or otherwise permitting the sample 110 to enter therein 105, can include configuring the injection device 115 to access the volume of the well 105 and to deposit the sample 110 therein 105.

The method can include configuring a light source power supply 122 to control an intensity of the light source 120 within a range of intensities between 0 and 500 lux according to a voltage setting of the light source power supply 122, thereby tuning an amount of light transmitted as an EOT transmission through the NHA sensors of the photonic sensor chip 125 for improved detection of the change undergone by the sample 110 in the well 105 according to the calorimetry measurement.

Measuring transmission of light can include capturing, and storing in memory, video data representing light transmitted as an EOT transmission at least through the NHA sensors of the photonic sensor chip 125 disposed at the bottom of the well 105. If the stored video data includes color video data, the color video data can be converted to black and white video data. The method can further include cropping the video data and, identifying bright spots corresponding to individual NHA sensors, represented in the stored video data by i) comparing, with a brightness threshold value, brightness information corresponding to pixels represented within the stored video data, and ii) determining locations within the view where the brightness information exceeds the threshold value. Brightness information corresponding to pixels represented within the stored video data for a given individual NHA sensor can be averaged. The averaging can be performed spatially over a pixel array of pre-defined dimensions, the pixel array defining a region that includes at least part of the given NHA sensor.

The method can include applying heat to the well with a heating device 107 before the measuring of transmission of light.

FIGS. 2A-2B illustrate an example arrangement of NHA sensors of a photonic sensor chip 125 to be used in micro-calorimetry systems such as the system 100. Incident light 224 irradiates a sample 110, such as a fluid sample, or a dielectric layer 226 disposed thereunder. An inner gold-film layer 227-1 includes nanohole arrays 227-2 configured to produce an EOT signal 229 that passes through a dielectric substrate 228.

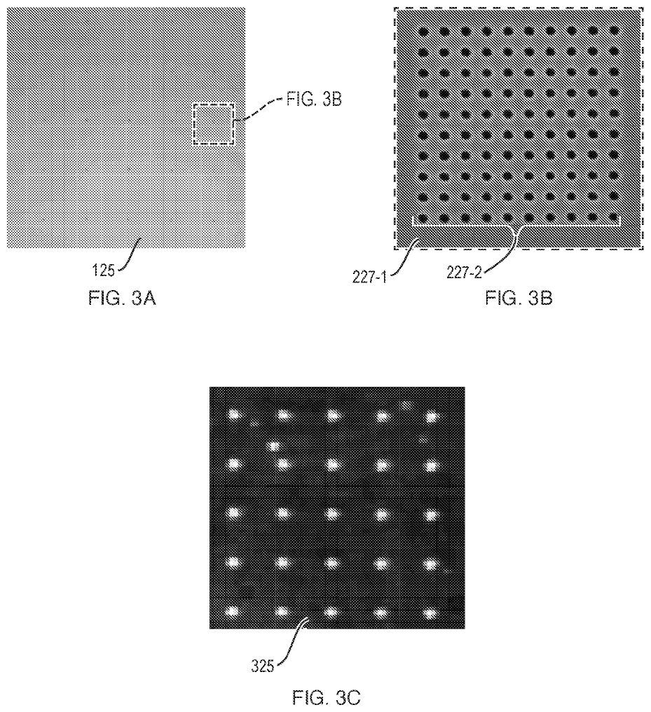

FIG. 3A includes a close-range view of an example arrangement of NHA sensors of a photonic sensor chip 125 to be used in micro-calorimetry systems such as the system 100 according to embodiments of the present disclosure, and a magnified view of a single NHA sensor of the photonic chip 125.

FIG. 3B is a close up view of gold film layer 227-1 including nanohole arrays 227-2.

FIG. 3C is a graphically displayed still representation 325 of video data captured by a light detector 130 used in micro-calorimetry systems such as the system 100. The displayed video data shows EOT observed by NHA sensors across a photonic chip 125.

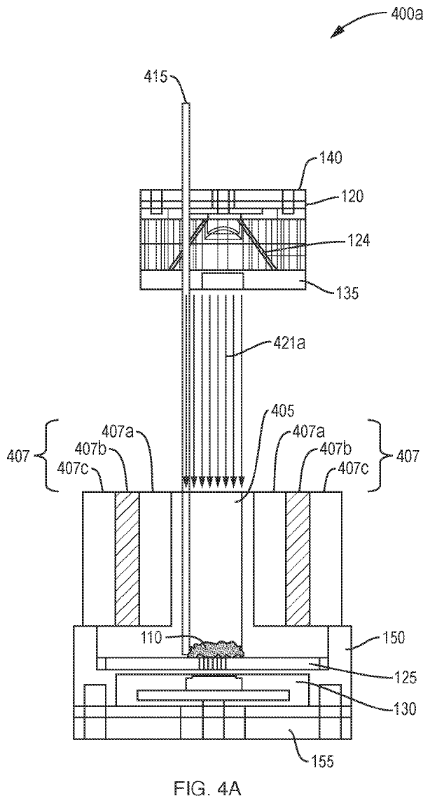

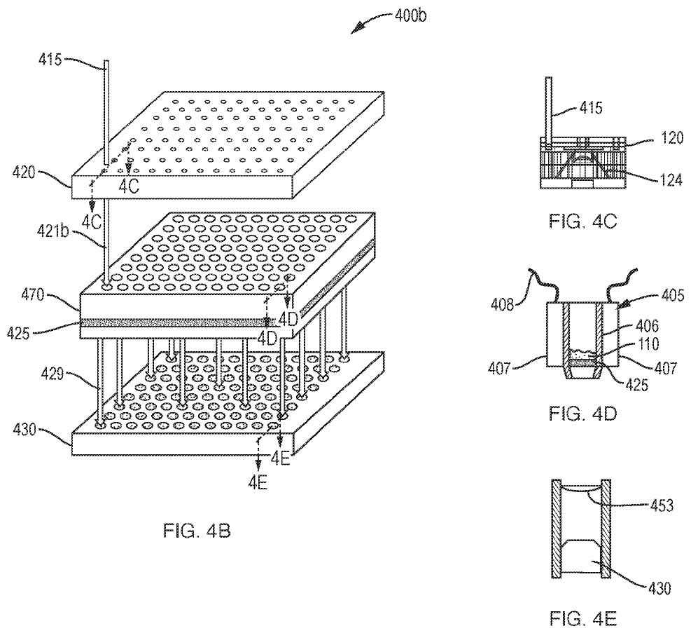

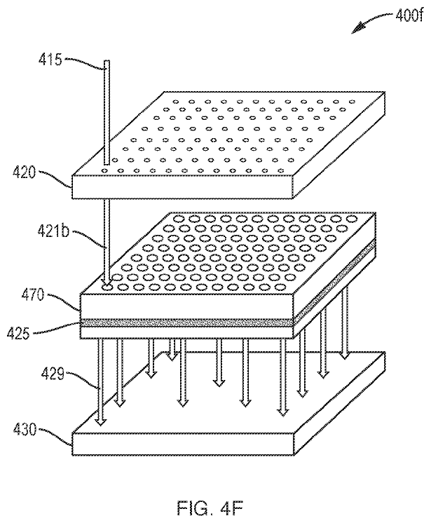

FIG. 4A is a schematic diagram of an example calorimetry unit 400a to be used in a well plate embodiment of a micro-calorimetry system 100. An input feature 115 includes a micro-pipette 415. Collimated light 421a passes through a well 405 and irradiates a sample 110 at the bottom of the well 405. Transient heating device 107, comprised of outer sleeve 407c, inner sleeve 407a and enclosed heating wire, or foil heater 407b, is electronically coupled to the variable DC power supply 108.

FIG. 4B-E are schematic diagrams of an example implementation 400b of calorimetry units to be used in a well-plate embodiment of a micro-calorimetry system 100. A well 405 formed by well wall 406 is shown to contain a liquid sample 110 above a photonic sensor chip 425. Each well includes one or more individual photonic sensor chips 425. Typically, each well include one sensor chip 425, which may form or be positioned at the bottom of the well. Circumferential heater 407 (transient heating device 107) includes a heating element, such as foil or heating wire, is wrapped around the vertical chamber of each well 405 and are controlled by an external circuit and computer. Micro-pipette 415 may be a robotically controlled injection device. In the preferred embodiment, a single light source assembly 420 may be configured to illuminate a single well in a well plate, for example, 96 wells would utilize 96 light sources. Light beams 421a-b are shown to be incident upon the wells. Some light beams 421a-b are omitted for clarity. A modified 96 well plate 470 is shown to include at least one photonic sensor 425 in each well. EOT transmissions 429 are shown emanating from the photonic sensors 425. Some EOT transmissions 429 are omitted for clarity. A light detector assembly 430 and recording device are to capture data for each well 405 individually. An optical system 453 may include a lens configured to focus EOT transmissions 429 upon the light detector system 430.

FIG. 4C shows a schematic view of the light source assembly 420. The light source 120 includes a light-emitting diode (LED) and a collimator 124 operatively coupled with the LED to control a direction of rays of light emitted by the LED. The input feature 415, also referred to as the micropipette, dip stick, or injection feature passes through the light source assembly 420, and enters the well 405 off center so as to allow room for the sample. This input feature 415 can be electronically controlled. Multiple input feature 415 can be sued together to simultaneously inject samples into multiple wells.

FIG. 4D shows a schematic view a single well 405, formed by the well wall 406. At the bottom of the well 405 is the sample 110 resting on the photonic sensor chip 425. A circumferential transient heating device 407 is positioned about the perimeter of the well, and includes electrical connections 408 which are electrically coupled to the variable DC power supply 108. The transient heating device 407 also provides thermos-insulating properties thermos-isolating each well, which avoids cross-talk between wells to improve measurements.

FIG. 4E shows an embodiment of an optical system 453, which may include a lens configured to focus EOT transmissions 429 upon the light detector system 430, in an embodiment utilizing an individual light detector 430 for each well of the plurality of wells.

FIG. 4F shows a similar configuration 400f to 400b. In FIG. 4F, however, the light detector assembly and recording device 430 are configured to capture the EOT transmitted through each of the photonic sensor chips 425 in the plurality of wells 405 in the well plate 470 as one image containing data for all wells 405.

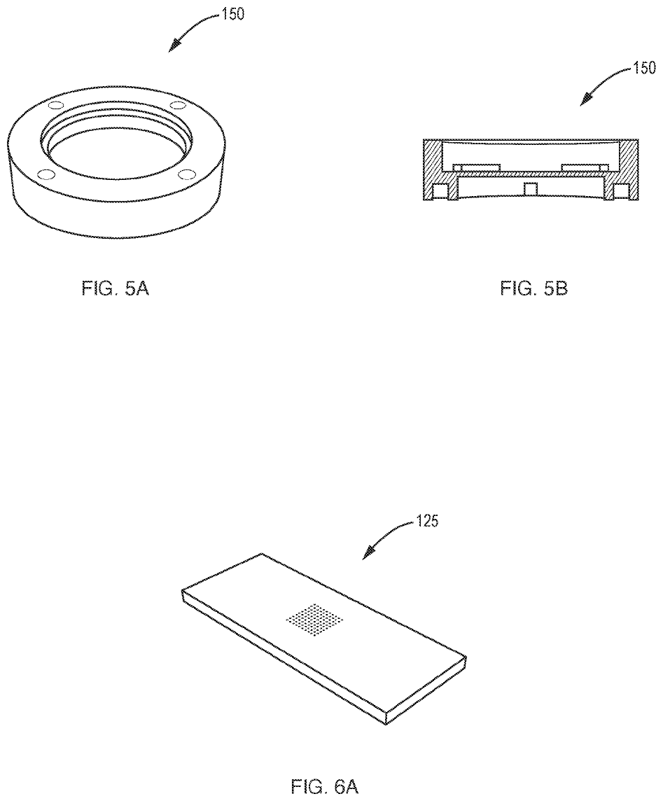

FIG. 5A is a perspective view of a frame element 150 for holding a light source of an example calorimetry unit.

FIG. 5B is a cross-sectional view of frame element 150 for holding a light source

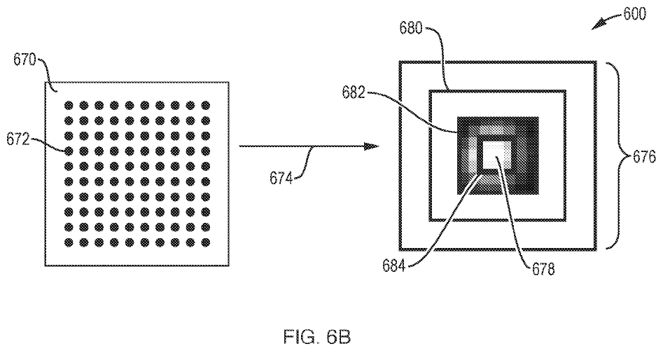

FIG. 6A is a perspective view of a Nano Hole Array (NHA) chip 125.

FIG. 6B is a diagram 600 illustrating the pixel averaging procedure according to embodiments. The diagram 600 includes an expanded, i.e., magnified view 670 of a single NHA sensor comprising an array of individual nanoholes 672. Multiple such sensors may be arranged within a well. Upon acquisition of video data 674 during an EOT measurement, black-and-white brightness data corresponding to a given NHA sensor 676 is produced. Pixels further from a given bright spot 678, with brightness data indicating a darker appearance relative to the given bright spot 678 and thus less EOT versus the center of the sensor, still contain valuable information to be incorporated by the pixel averaging procedure, despite the low intensity of illumination of such pixels. As such, different dimensions of a pixel array, substantially centered upon the given bright spot, provide different signal-to-noise ratios for brightness data averaged spatially over the pixel array. In the diagram 600, pixel arrays of different dimensions are shown superimposed over a representation of video data for the given NHA sensor 676, including a 13×13 array 680, a 7×7 array 682, and a 3×3 array 684.

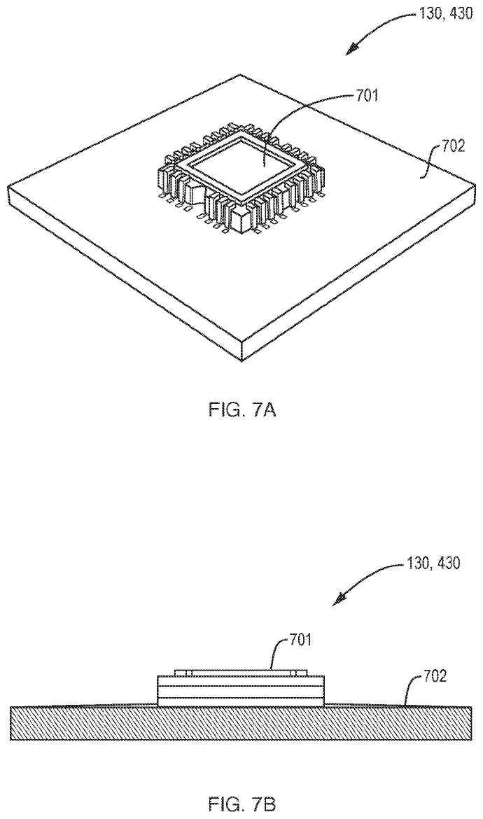

FIGS. 7A-7B illustrate an example light detector 130, 430 suitable for use with embodiments described herein. The light detector includes a CCD chip 701 mounted on a printed circuit board 702.

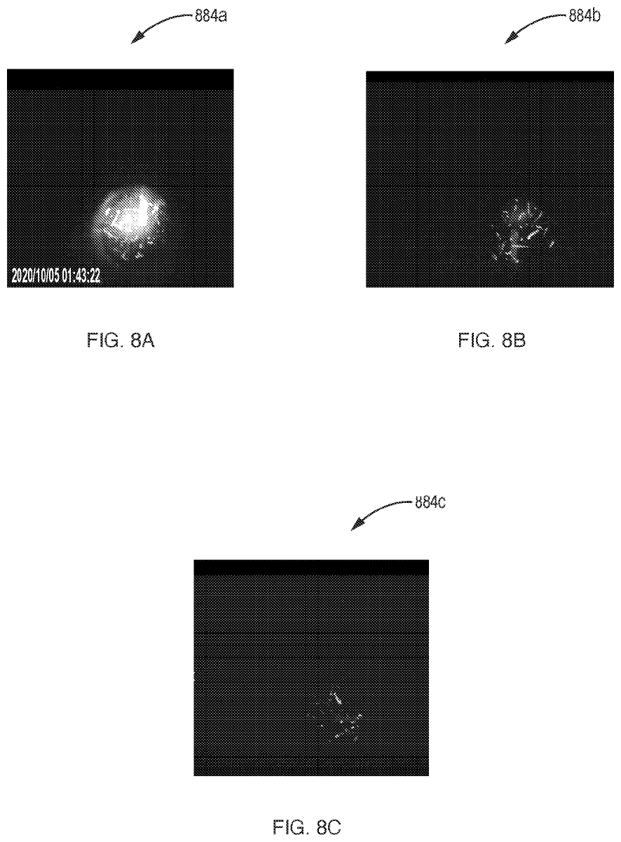

FIGS. 8A-8C are images 884a-c of extraordinary optical transmission (EOT) 429 through an NHA sensor chip 125 of an example calorimetry unit to be used in a micro-calorimetry system 100, as viewed by a light detector 130. FIG. 8A shows a situation in which incident light is too intense, thus saturating the light detector. In FIG. 8B, an appropriate level of EOT is realized, allowing easy detection of changes in EOT. In FIG. 8C, an EOT signal is too weak to sufficiently discern.

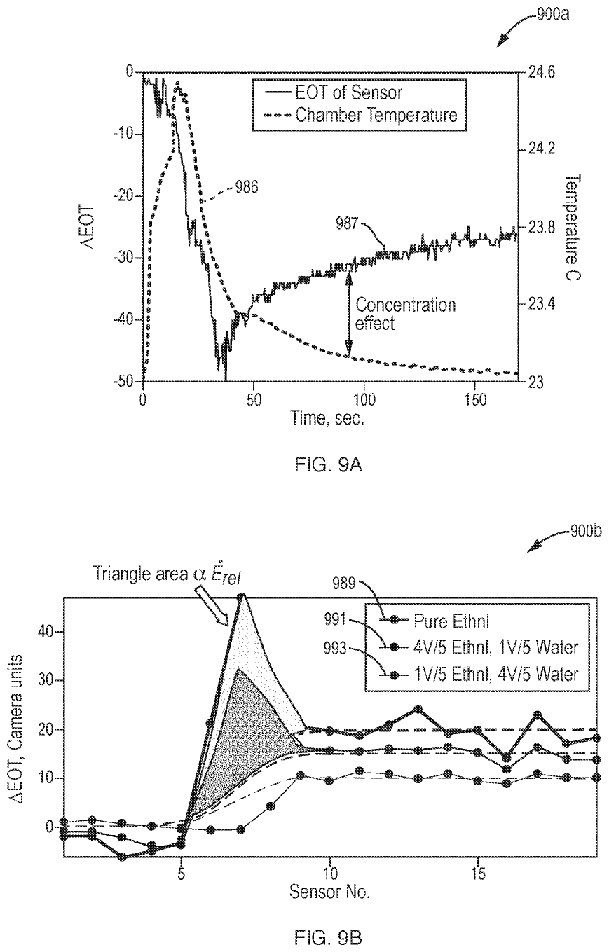

FIG. 9A is a plot 900a of EOT versus time and well temperature versus time for multiple NHA sensors in the well. In the example of FIG. 9A, the EOT values depicted in the plot 900a represent averages of measured EOT for 1300 sensors. EOT values may alternatively be averaged over different numbers of NHA sensors as appropriate in a given system. EOT measurements are thus synchronized with a known heat rate as heat is applied to the sample-populated well. EOT is indicated as a differential measurement AEOT, taken as a difference with respect to a starting EOT value. Any of the EOT measurements referred to herein may be so implemented. EOT curve 987 is seen in FIG. 9A to drop off immediately as heat begins to be applied as indicated by temperature curve 986. As the sample in the well undergoes a change in response to the applied heat, the EOT is seen to reach a minimum value before gradually increasing again, as the well temperature due to applied heat peaks and subsequently decays.

FIG. 9B is a plot 900b of EOT versus individual NHA sensor for three different concentrations of a pair of sample fluids within a test chamber, obtained in an embodiment. EOT curves are shown for the different concentrations, including a pure ethanol EOT curve 989, an EOT curve for 80% ethanol-water solution 991, and an EOT curve for a 20% ethanol-water solution 993. Such EOT curves for different concentrations of the pair of sample fluids are indicative of different amounts of energy released upon heating of the samples, with pure ethanol releasing the most energy, and the 20% solution releasing the least energy, as a skilled person would expect. The plot for the pure ethanol solution 989 and the plot for the 80% solution 991 indicate that a bulk of the released energy was detected by sensor numbers 6, 7, and 8. The shaded triangular regions indicate heat released by reactions.

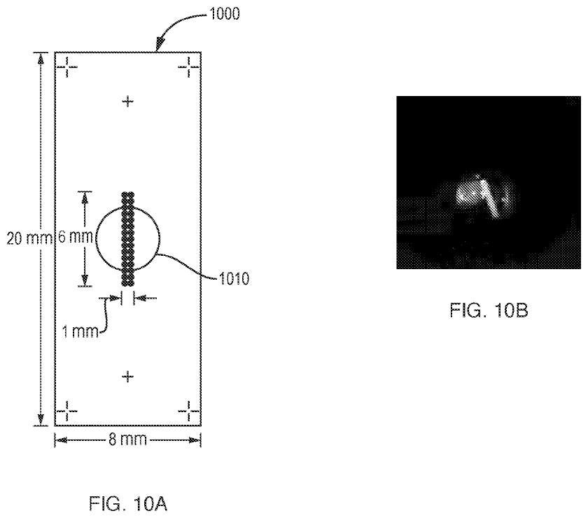

FIG. 10A is a schematic diagram of an exemplary photonic sensor chip 1000 measuring 20×8 mm, and containing a NHA sensor strip measuring 1×6 mm.

FIG. 10B shows the light detector view 1010 showing the aperture of a light detector 430 viewing one individual well 405.

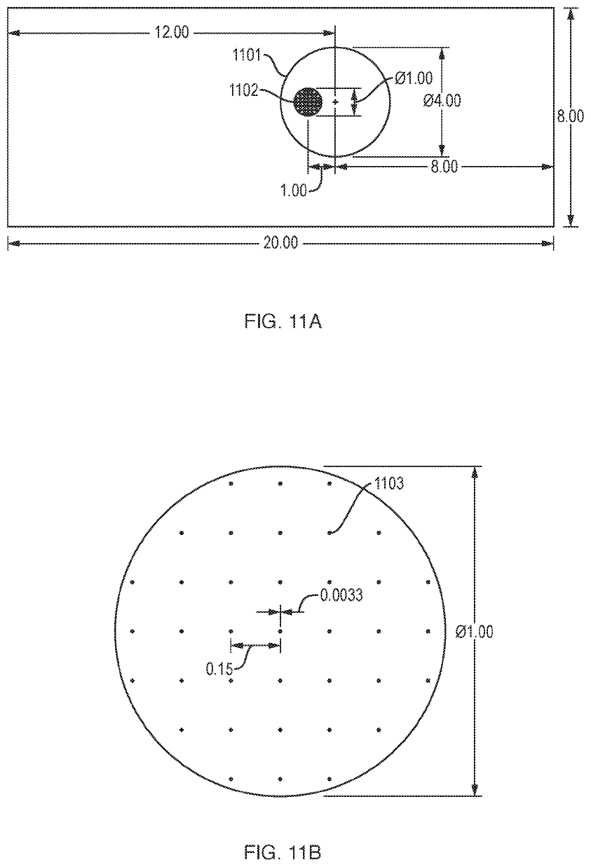

FIG. 11A is a schematic diagram of an exemplary photonic sensor chip measuring 20×8 mm containing a NHA array according to an embodiment. The photonic sensor chip can either be manufactured, or cut, to the dimensions of the 4 mm diameter 1101. The photonic sensor chip 1101 includes the round NHA 1102 located off center in the photonic chip to allow space for the injection device.

FIG. 11B is an enlarged view of exemplary NHA 1102 containing a plurality of nanoholes 1103. Exemplary NHA 1102 measures 1 mm in diameter and contains a plurality of nanoholes 1103 spaced evenly throughout the area of NHA 1102. The nanoholes 1103 measure 0.0033 mm across, and in this exemplary embodiment, are spaced 0.15 mm apart.

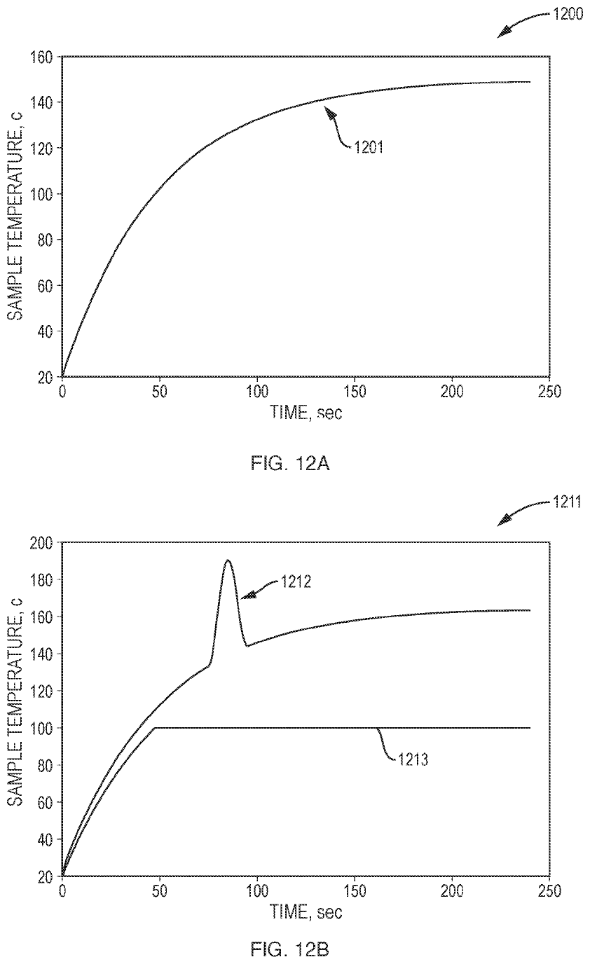

FIG. 12A shows a plot 1200 representing a sample undergoing transient thermal increase within a well in response to an applied heat. Curve 1201 represents the temperature of an exemplary sample within the well. Plot 1200 shows a situation where the exemplary sample within the well does not undergo a reaction, nor folding or unfolding of a protein, denaturing of the compound, nor a phase change. Instead, curve 1201 in plot 1200 shows that the temperature of the exemplary sample exhibits the expected exponential type response to a heating source that produces an expected rate of change of the temperatue.

FIG. 12B shows a plot 1211 representing the transient temperature change of two different samples within two different wells, in response to applied heat. Curve 1212 represents the temperature of an exemplary sample within the well. Plot 1211 shows that at about 75 s into the test, curve 1212 undergoes a reaction at about 130 degrees Celcius, indicated by the spike in temperature. Curve 1213 represents the temperature of a different exemplary sample undergoing a phase change within the well. Plot 1211 shows that curve 1213 increases exponentially in temperature for 40 s, until it reaches 100 degrees Celcius; then, the sample remains at 100 degrees Celcius for the remainder of the test. For example, a sample of water undergoing the transient thermal increase will increase in temperature in response to an applied heat only until 100 degrees Celcius; the sample will not increase its temperature any further because at that point the water has changed phase, and can nolonger rise in temperature. Put another way, both curve 1212, and 1213 shows a respective exemplary sample undergoing a change in response to a transient thermal increase.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

The invention claimed is:

1. A system for calorimetry, the system comprising:
a) a plurality of wells disposed upon a well plate, each well having a volume for receiving a respective sample;
b) an input feature, including an injection device configured to access the volume of each of the plurality of wells and deposit the respective sample therein;
c) a plurality of light sources configurable to irradiate each of the plurality of wells and the respective sample with incident light;
d) a plurality of photonic sensor chips, each photonic sensor chip disposed at or forming a bottom of a corresponding well of the plurality of wells, the photonic sensor chip comprising plural nanohole array (NHA) sensors integrated upon a substrate;
e) a light detector configured to measure transmission of light through the NHA sensors to obtain a series of optical transmission measurements;
f) a heater in thermal contact with each of the plurality of wells;
g) a heater controller coupled to the heater, the heater controller programmed to control the heater to apply a transient thermal increase to each well, to increase the temperature within the well at a known heat rate, with the sample provided therein; and
h) a processor configured to calculate, for each well, a calorimetry measurement as a function of the series of optical transmission measurements and the transient thermal increase, the calorimetry measurement being indicative of the sample within the well undergoing a change in response to the transient thermal increase, wherein the change for each sample relates to a property of the sample.

2. The system of claim 1, further comprising at least one power supply configured to independently control the intensity of the light sources within a range of intensities between 0 and 500 lux, according to a voltage setting of the at least one power supply.

3. The system of claim 2, wherein the at least one power supply is spatially separated from the calorimetry unit and includes at least one battery, or a switchable DC power supply device.

4. The system of claim 1, wherein each light source includes a light-emitting diode (LED) and a collimator operatively coupled with the LED to control a direction of rays of light emitted by the LED.

5. The system of claim 1, wherein the heater is positioned as a peripheral heater in thermal contact with a perimeter of each of the plurality of wells.

6. The system of claim 5, wherein the heater comprises plural peripheral heaters, and wherein each well of the plurality of wells is in thermal contact with an individual peripheral heater.

7. The system of claim 1, further comprising frame elements configured to secure and mutually couple the light sources, the photonic sensor chip of each well, the light detector, and the input feature to form a calorimetry unit for each well.

8. The system of claim 7, further comprising a lens configurable to focus, upon the light detector, light transmitted as an optical transmission through the NHA sensors of each of the photonic sensor chips of the plurality of wells, the system further comprising a lens frame element configured to secure the lens and to be mutually physically coupled with one or more other frame elements of the calorimetry unit.

9. The system of claim 1, wherein the light detector comprises a plurality of light detectors, each of the plurality of light detectors arranged to measure light transmitted as an optical transmission through the NHA sensors of one well of the plurality of wells.

10. The system of claim 1, further comprising an optics controller configured to control aspects of at least one of the light sources and the light detector, the system further comprising memory configured to store data acquired from the light detector.

11. The system of claim 10, wherein the processor, the optics controller, and the memory are integrated within an electronic microcontroller device operatively coupled with, and spatially separate from, the calorimetry unit.

12. The system of claim 10, wherein:
a) the optics controller is programmed to cause the light detector to capture, and store in the memory, video data comprising a plurality of image frames for a view of all of the NHA sensors of the plurality of wells;
b) the processor is further configured to crop each of the image frames, containing a view a view of all of the NHA sensors of the plurality of wells, into a plurality of cropped image frames, each cropped image frame containing a view of a corresponding individual well of the plurality of wells, wherein for each of the plurality of cropped image frames the processor uses the information from the cropped image frame to calculate the calorimeter measurement for the corresponding individual well.

13. The system of claim 12, wherein for each of cropped image frames:
a) if the stored video data includes color video data, the processor is configured to convert the color video data to black and white video data;
b) the processor is further configured to identify bright spots, corresponding to individual NHA sensors, represented in the stored video data by:
i) comparing, with a brightness threshold value, brightness information corresponding to pixels represented within the stored video data;
ii) determining locations within the view where the brightness information exceeds the threshold value; and
c) the processor is further configured to average brightness information corresponding to pixels represented within the stored video data for a given individual NHA sensor, the averaging performed spatially over a pixel array of pre-defined dimensions, the pixel array defining a region that includes at least part of the given NHA sensor.

14. A method for calorimetry, the method comprising:
a) providing a sample to each of a plurality of wells disposed upon a well plate;
b) via an input feature configured to access the volume of each of the plurality of wells and depositing the respective sample therein;
c) configuring a plurality of light sources to irradiate each of the plurality of wells and the respective sample with incident light;
d) measuring, via a light detector, transmission of light through plural nanohole array (NHA) sensors to obtain a series of optical transmission measurements, the NHA sensors integrated upon a substrate of a photonic sensor chip disposed at or forming a bottom of each of the plurality of wells;
e) controlling a heater to apply a transient thermal increase to each well, increasing the temperature within each well at a known rate; and
f) calculating, for each well, a measurement as a function of the series of optical measurements and the transient thermal increase for each well, the calorimetry measurement being indicative of the sample in the well undergoing a change in response to a transient thermal increase to the well, wherein the change for each sample relates to a property of the sample.

15. The method of claim 14, wherein the input feature includes an injection device, and wherein providing the sample to a well of the plurality of wells includes configuring the injection device to access the volume of each well and to deposit the sample therein.

16. The method of claim 14, further comprising configuring at least one power supply to independently control an intensity of the light sources within a range of intensities between 0 and 500 lux according to a voltage setting of the at least one power supply, thereby tuning an amount of light transmitted as an optical transmission through the NHA sensors of the photonic sensor chips for improved detection of the change undergone by the sample in each of the plurality of wells according to the calorimetry measurement.

17. The method of claim 14, wherein the measuring transmission of light includes:
a) capturing, and storing in memory, video data representing light transmitted as an optical transmission at least through the NHA sensors of the photonic sensor chip of each of the plurality of wells;
b) if the stored video data includes color video data, converting the color video data to black and white video data;
c) identifying bright spots, corresponding to individual NHA sensors, represented in the stored video data by;
i) comparing, with a brightness threshold value, brightness information corresponding to pixels represented within the stored video data;
ii) determining locations within the view where the brightness information exceeds the threshold value; and
d) averaging brightness information corresponding to pixels represented within the stored video data for a given individual NHA sensor, the averaging performed spatially over a pixel array of pre-defined dimensions, the pixel array defining a region that includes at least part of the given NHA sensor.

18. The method of claim 14, further comprising:
a) programming an optics controller to cause the light detector to capture, and store in memory, video data comprising a plurality of image frames for a view of all of the NHA sensors of each of the plurality of wells;
b) cropping the image frames containing a view of all of the NHA sensors of each of the plurality of wells into cropped image frames, each cropped image frame containing a view of an individual well of the plurality of wells, wherein for each of the plurality of cropped image frames.

19. The method of claim 18, wherein for each of cropped image frames:
a) if the stored video data includes color video data, converting the color video data to black and white video data;
b) identifying bright spots, corresponding to individual NHA sensors, represented in the stored video data by;
i) comparing, with a brightness threshold value, brightness information corresponding to pixels represented within the stored video data;
ii) determining locations within the view where the brightness information exceeds the threshold value; and
c) averaging the brightness information corresponding to pixels represented within the stored video data for a given individual NHA sensor, the averaging performed spatially over a pixel array of pre-defined dimensions, the pixel array defining a region that includes at least part of the given NHA sensor.

20. The system or method of claim 19,
wherein the optical transmission is extraordinary optical transmission (EOT).
